(19) United States
(12) Patent Application Publication
(10) Pub. No.: US 2026/0233258 A1
(43) Pub. Date: Aug. 13, 2026

(54) PORTABLE WASH STATION

(71) Applicant: BOLD CORPORATION LIMITED, Orpington (GB)

(72) Inventor: Bolaji TAIWO, Orpington (GB)

(21) Appl. No.: 19/637,884

(22) Filed: Apr. 2, 2026

Related U.S. Application Data
(63) Continuation of application No. PCT/IB2024/059308, filed on Sep. 25, 2024.

(30) Foreign Application Priority Data
Oct. 4, 2023 (GB) GB 2315212.7

(51) Int. Cl. B08B 3/04; B62B 1/12; B62B 1/16; B62B 5/06; B65D 21/08; B65D 25/28; B65H 75/40; B65H 75/44; B60S 3/04

(52) U.S. Cl. CPC B08B 3/04; B62B 1/12; B62B 1/16; B62B 5/06; B65D 21/086; B65D 25/2811; B65H 75/403; B65H 75/4471; B60S 3/044; B62B 2202/50; B65H 2701/33

(57) ABSTRACT

The present invention relates to a portable wash station comprising: a collapsible wheeled container with a base and a plurality of side walls that is configured to be arranged in a first collapsed position in which the base and side walls are parallel to one another and a second box position in which the base and side walls are assembled to define an open top storage box; an extendable handle provided on one side wall; and a reel that holds a hosepipe provided on an outer face of one side wall t.

### FIELD OF THE INVENTION

The present invention relates to a portable wash station, in particular a collapsible wash station that can be compacted when not in use.

### BACKGROUND

There is often a requirement to clean a vehicle or equipment after use to help maintain best condition.

Often the cleaning is conducted at home, or at a cleaning location such as a carwash.

However, it can often be necessary for cleaning to be completed when away from home, or a usual cleaning location, for example when away on holiday.

Cleaning equipment can be bulky with hoses, attachments and cleaning liquids required.

Therefore it may not be practical to take cleaning equipment away.

The present invention provides a portable wash station that enables cleaning equipment to be easily transported and compacted when not in use.

### PRIOR ART

US patent application US2004/0195346 (MCINTYRE) discloses a portable wash station for aiding in washing automobiles.

Chinese patent application CN110053653 (JUNJIAN) discloses a multi-functional trailer device with a foldable and telescopic flexible plastic box.

Chinese patent application CN210611302U (FANG) discloses a multifunctional folding box.

### SUMMARY OF THE INVENTION

According to a first aspect of the present invention there is provided a portable wash station comprising: a collapsible wheeled container with a base and a plurality of side walls that is configured to be arranged in a first collapsed position in which the base and side walls are parallel to one another and a second box position in which the base and side walls are assembled to define an open top storage box; an extendable handle provided on one side wall; and a reel that holds a hosepipe provided on an outer face of one side wall that is connectable to a water dispensing tool.

In this way the portable wash station can be arranged in a compact configuration that is easily transported and stored when not in use and an in use configuration in which the box container is assembled to provide storage for washing equipment or optionally for a reservoir of water if a water connection is not available.

The container is formed from the base and side walls.

Preferably the container forms a rectangular open topped box comprised from a rectangular base with four side walls extending upwards from edges of the base.

Ideally the base and side walls are formed from a strong, durable, and lightweight material such as aluminium or synthetic plastics, or a combination of these or similar materials.

Typically the base includes at least one aperture to allow drainage of water that may accumulate during washing.

For example the base may be a grill with a plurality of slots to allow release of water.

In some preferred embodiments the side walls have a raised and lowered surface, for example including ribs, to provide additional strength to the substantially flat wall and the raised and lowered surface may also provide support ledges for internal trays.

The container is wheeled to enable the wash station to be portable.

Preferably the base, or one of the side walls includes an axle that supports two wheels.

In this way the wash station can be tilted and wheeled by means of the handle, and when not titled the wash station is secure and will not roll away.

Preferably the wheel axle is arranged to be on an edge of the side wall that corresponds to the side wall that includes the handle.

In this way the wash station can be most easily tilted and wheeled.

In some embodiments the container has at least one foot in addition to the wheels to keep the wash station level on the ground and to prevent turning of the wheels unless the wash station is titled to engage the wheels.

In a preferred embodiment one or more side wall is formed from two or more connecting parts.

In this way side walls can be formed from smaller parts that are easier to store in the collapsed configuration.

The side walls and/or parts of each side wall are connected together to form the container.

In a preferred embodiment the adjacent side walls are joined at corners by at least one displaceable clip.

In some embodiments the clip may function as a hinge so that adjacent side walls can pivot with respect to each other whilst remaining connected.

In another embodiment the side walls are connected by separable hinges.

The side walls are adapted to receive the base, so that the base may engage with the side walls or provide support for the base.

For example an inner face of the side walls may include a raised portion that provides a ledge on which the base can be supported.

The side walls may additionally or alternatively connect to the base, for example using hinges, clips or may interlock.

In this way the base and side walls of the container can be easily assembled and disassembled.

In a preferred embodiment the base is attached to one side wall by at least one hinge so that the base can pivot parallel to the side wall when in the collapsed position.

In some embodiments the container includes at least one internal tray for supporting items such as washing liquids, sprays sponges and cloths.

The tray is ideally a displaceable part that is located once the container is assembled.

In some embodiments an inner face of the side walls may include at least one raised ledge or at least one recessed portion that provides a ledge on which the tray can be supported.

In a preferred embodiment the side walls are adapted to receive the tray by a projecting ledge on an inner face of the side wall upon which the tray is supported.

Ideally the tray is support around one third of the way from the top of the side wall so that any items are supported above the base and therefore easier to reach.

When the container is in the collapsed configuration, the tray is removed and preferably is stored parallel to the side walls.

In some embodiments the tray is folded when in the collapsed configuration.

In a preferred embodiment the tray is stored on an outer face of the side wall that includes the reel.

Preferably the tray connects at two separate locations.

For example the tray may include a tab with a first hole that is received on a protrusion and a second hole that receives a turning handle for the reel.

In this way the tray is securely fixed to an outer face of the wash station when in the collapsed configuration and additionally the reel is locked in position and cannot turn.

When the container is provided in the collapsed configuration all side walls are arranged to be parallel one to another.

This may be achieved by hinges that permit the side walls to fold together, or the side walls may be separate and stacked and secured parallel to one another.

In a preferred embodiment the container has a base with first, second, third and fourth side walls connected one to another by first hinges.

The first side wall includes the handle and reel.

The third side wall is opposed to the first side wall.

The second and fourth side walls are formed from two parts that are connected by second hinges.

This embodiment of the container is arranged in the collapsed configuration by complete the following steps:

(1) The base is pulled up to align parallel with the first and third side walls.

Preferable one side edge of the base is connected to either the first or third wall one of the sidewall by at least one hinges so that the base remains connected to the side wall when folded to the parallel orientation.

In another embodiment the base may be formed by two parts which are connected in the middle by at least one hinge.

The base remains connected to the first side wall or the third side wall when folded to the parallel orientation.

(2) The second and fourth side walls are each formed from two parts.

The two parts are separated or folded at the second hinges and each part is folded about its first hinge(s) so that one part becomes parallel and adjacent to the first side wall and the other part becomes parallel and adjacent to the third side wall.

(3) The first and third side walls are pushed together to be parallel one to another with the second and fourth side walls sandwiched therebetween.

In this way the second, third and fourth side walls all becomes stacked against the first side wall that includes the handle and reel.

It is appreciated that the side walls and base may be fold in different configurations to the example provided above to achieve all parts becoming parallel to each other in the compact configuration.

The portable wash station has an extendable handle so that the wash station can be easily titled and wheeled along to move the wash station from one place to another.

Preferably the extendable handle extends in the same axis as one of the side walls so that it extends upwards towards a user when in the assembled box configuration.

It is also appreciated that the handle is intended to remain useable when in the collapsed configuration and therefore the handle and side wall being in the same axis permits this.

In a preferred embodiment at least part of the handle is arranged in channel in the side wall from which the handle can be extended from and retracted into.

For example the handle may have a handgrip arranged on two arms that are extended from and retracted into two channels that run through one of the side walls.

In some embodiments channels may be provided on more than one side wall so that the position of the handle can be changed.

In some embodiments the handle may be telescopic.

For example the arms may have telescoping portions.

The reel which holds a length of hosepipe is arranged on an outer face of one of the side walls so that the reel can turn freely and can remain in place when the container is collapsed.

Preferably the reel turns about an axis that is perpendicular to the side wall so that the hosepipe is wound against the wall for the most compact configuration and to keep the wash station stable as the weight of the hosepipe is close to the side wall.

In a preferred embodiment the reel has a cover to enclose the hosepipe and ensuring it is guided and held in a fixed position against the side wall.

In a preferred embodiment the portable wash station has at least one bracket for receiving items that include the water dispensing tool and other items such as cleaning heads, spray nozzles and extension poles.

Preferably there is a plurality of brackets so that multiple items can be supported on the wash station and transported together.

In a preferred embodiment there is provided a mount upon which the at least one bracket is mounted.

Preferably the mount is arranged on the handle.

In this way the brackets are higher than the side walls making the items easier to reach by a user and allowing for longer items such as extension poles to be stored securely.

Preferably the brackets are external facing for ease of use.

The wash station is designed to both connect directly with a water mains supply or be connected to a standalone reservoir.

The standalone reservoir may be in the form of a flexible waterproof bag that is arranged in the container when assembled.

The standalone reservoir is filled and then transported as part of the wash station.

In some embodiments the portable wash station includes a water pump to pump water from a reservoir to the hosepipe.

This is advantageous when a mains water supply is not available and provides a means to enable the wash station to provide a pumped flow of water without a mains supply.

The water pump may be a displaceable part that is deployed when required or may be integrated with the wash station.

The water pump may be provided with a rechargeable battery to power the water pump or may be adapted to receive a power supply, for example having a port to receive a power cable.

In a preferred embodiment the water pump may be integrated with the mount, for example the water pump may be housed within the mount.

An inlet tube extends from the water pump to the reservoir of water so as to draw water from the reservoir through the pump and to exit through the hosepipe as a flow of pumped water.

For example, an inlet tube may pass from the water pump through or along the first side wall to a lower edge where a connector receives the outlet tube and connects through to the reservoir providing a flow channel from the reservoir to the pump.

The inlet tube may be concealed fully or partially within a side wall or through the handle arms.

The inlet tube may be extendable and may be stowed on or in the mount and deployed when required to a lower region, typically the base of the reservoir.

The water pump has an outlet that is connectable to or connected to the hosepipe.

The mount may also house at least one rechargeable battery connected to the integrated water pump to provide a source of power.

Preferably the mount with at least one rechargeable battery typically has at least one port (socket) to receive a plug or may include an integrated cable to charge at least one battery.

In this embodiment the mount may have a control means such as at least one switch, button or dial to operate and control the integrated water pump.

Preferably the integrated water pump can be operated to pump water from the reservoir to the hosepipe, or a water pump is placed in the standalone reservoir to pump water, from the reservoir to the hosepipe.

For example a rechargeable or 12V car socket water pump can be placed inside the standalone reservoir or the water pump may be integrated into the mount and have an inlet that extends to the reservoir to draw water through the inlet and direct this to the hosepipe (outlet).

The outlet from the water pump can be fed into the inlet of the wash station to provide a pumped supply of water.

It is appreciated that the standalone reservoir may be provided as an optional accessory with the wash station.

It is appreciated that in some embodiments at least one battery may also provide a power supply for other requirements, such as to power at least one light, or to provide a charging means or a power supply to an electronic device.

Preferred embodiments of the invention will now be described, by way of example and with reference to the Figures in which:

### BRIEF DESCRIPTION OF FIGURES

FIG. 1A shows a front perspective view of a preferred embodiment of the wash station in a collapsed configuration;

FIG. 1B shows a front perspective view of a preferred embodiment of the wash station in an assembled configuration;

FIG. 2A shows a rear perspective view of the preferred embodiment in the assembled configuration;

FIG. 2B shows a rear perspective view of the preferred embodiment in the collapsed configuration;

FIG. 2C shows a front perspective view of the wash station showing an internal tray;

FIG. 3A shows an exploded view of a rear perspective of the wash station; and

FIG. 3B shows a rear perspective of the wash station 100 in the collapsed configuration.

### DETAILED DESCRIPTION OF FIGURES

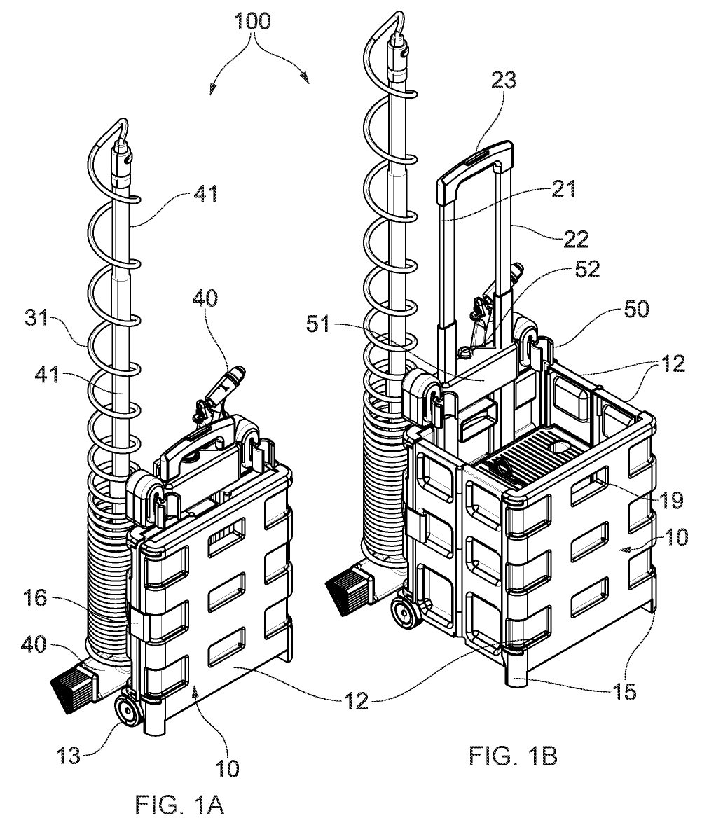

FIGS. 1 to 3 show a preferred embodiment of the portable wash station 100.

The portable wash station 100 has a collapsible wheeled container 10 formed from a base 11 and a plurality of side walls 12A, 12B,12C, 12D that are configured to be arranged in a first collapsed position (FIG. 1A) in which the base and side walls are parallel to one another and a second position (FIG. 1B) in which the base and side walls are assembled to define an open top storage box.

The collapsible container 10 includes a pair of wheels 13 on an axle 14 and two feet 15.

The two wheels 13 and two feet 15 are each provided at lower corners of the container to engage with the ground.

In the pictured embodiment the wheels 13 and feet 15 are provided on a lower end of opposed side walls 12.

The wash station 100 is tilted when wheeled so that the two feet are removed from the ground and the wheels 13 are engaged to roll the wash station 100 along the ground.

The side walls 12A (first), 12B (second), 12C (third) and 12D (fourth) are joined one to another by clips 16 that function as first hinges to enable the adjacent side walls to pivot with respect to each other.

Side wall 12A is opposed side wall 12C when assembled and side wall 12B is opposed to side wall 12D.

Side walls 12A and 12C are the same dimensions and side walls 12B and 12D are the same dimensions.

Opposed side walls 12B and 12D are each formed from two rectangular parts that are connected together by at least one separable second hinge 12E which enables the rectangular parts to be separated at the second hinge(s) and folded at the first hinge(s) which enables a quick transformation to the collapsed configuration and vice-versa.

Side wall 12C has a grasp hole 19 to assist with lifting the work station 100.

All side walls 12 are formed from synthetic plastics that have been moulded to have a raised and lowered surface for enhanced strength.

The collapsible container 10 has a base 11 formed from two parts 11A, 11B.

The parts have slots 19 to allow draining of liquid.

The base 11 is connected to either first side wall 12A or third side wall 12C at least by one clip which functions as a hinge.

The collapsible container 10 has a removable internal tray 60 formed from two parts 60A, 60B.

The tray parts 60A, 60B have an interlocking means 64 so that the parts interlock together to form a single tray that sits on ledges 18 that extend from an internal face of the side walls 12B, 12C, 12D.

When the container 10 is arranged in the collapsed position the tray parts 60A, 60B are removed and folded together, pivoting about the interlocking means 64 which function as a hinge so that the tray parts 60A, 60B are parallel to each other.

The folded tray parts 60A, 60B are the stored on an outer face of a side wall.

Each tray part 60A, 60B has an aperture 61 to assist with connecting the tray parts 60A, 60B to the wash station 100 when in the collapsed configuration.

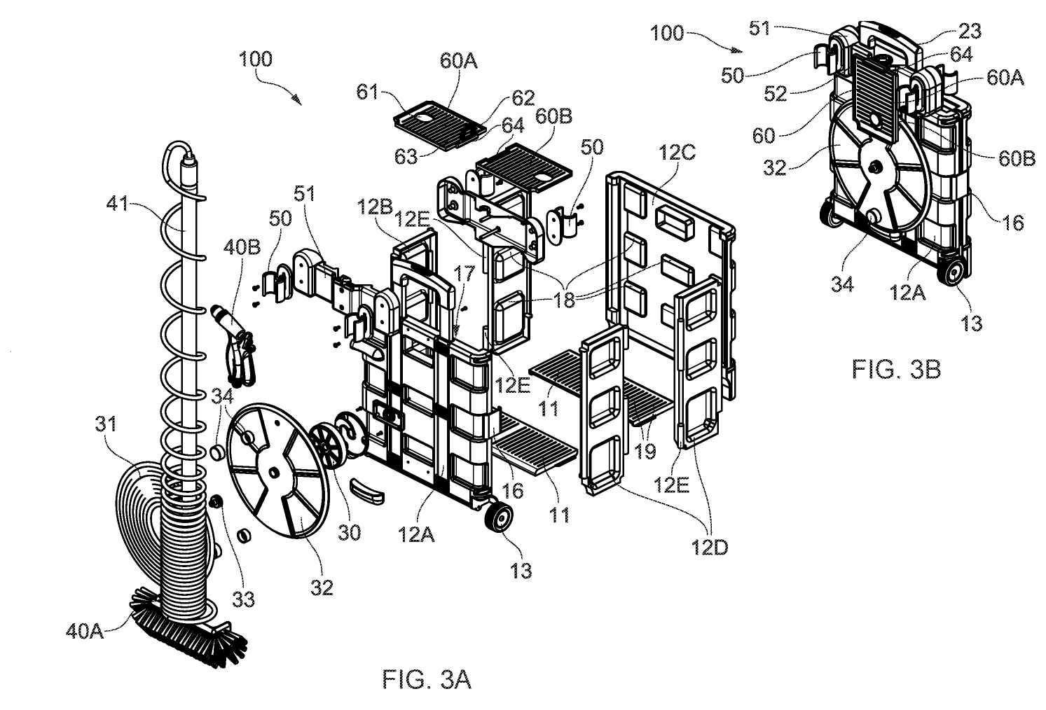

In the pictured embodiment the tray parts 60A, 60B both have an aperture 61 for receiving a projection 34 so that the trays 60A, 60B can be mounted in a fixed position when the container 10 is collapsed (see FIG. 3B).

The second tray part 60B is arranged behind the first tray part 60A so that the tray parts 60A, 60B are parallel one to another.

In the pictured embodiment the projection 34 is a handle for the reel 30 that is arranged on the cover 32.

The cover 32 and handles 34 are provided on an outer face of the first side wall 12A.

The first tray part 60A also has a tab 62 with a hole 63 for further locating the first tray part 60A on the first side wall 12A when the container 10 is collapsed (see FIG. 3B).

The tab 62 extends in an axis that is perpendicular to the axis of the tray 60A.

The hole 63 receives a protrusion 52 provided on the mount 51 to secure part of the tray 60A in place and thereby also the second tray part 60B that is folded about the interlocking means 64 to be parallel to the first tray part 60A.

When the hole 63 in the tab 62 of part of the tray 60A is engaged with the protrusion 52, and both holes 61 in the tray parts 60A, 60B are engaged with the projection 34, the tray parts 60A, 60B are fixed in the collapsed configuration and this arrangement also acts to lock the reel and prevent rotation when the wash station is in the collapsed configuration.

The tray 60 forms a platform to store all bottled cleaning products in one place.

The wash station 100 has an extendable handle 20 provided on the first side wall 12A.

The handle has two arms 21, 22 that are received in channels 17 provided through the first side wall 12A.

The two arms 21, 22 are joined by a handgrip 23.

The handle 20 is extendable by displacement of the arms from the channels 17.

A reel 30 that holds a hosepipe 31 is provided on an outer face of the first side wall 12A.

The hosepipe 31 is connectable to the water dispensing tool 40.

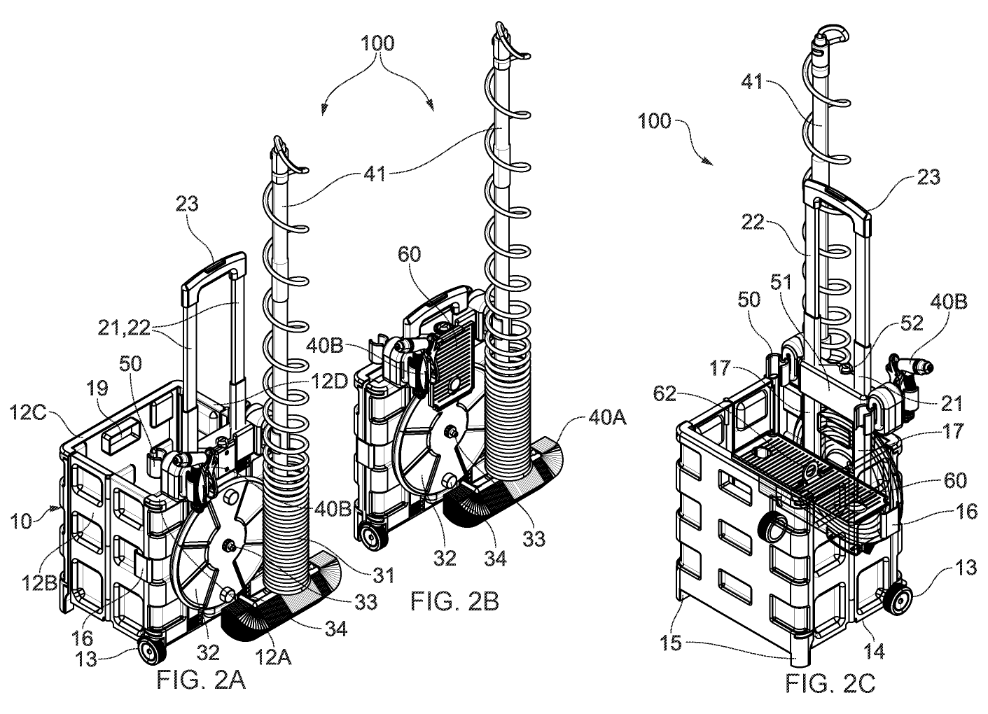

The hosepipe 31 is arranged on the reel 30 so that the hosepipe 31 is in a coil that is parallel to the first side wall 12A (see FIG. 2C) so that the reel 30 and hosepipe 31 are adjacent the side wall 12A.

The reel 30 has a cover 32 that holds the reeled hosepipe 31 in place and guides the hosepipe 31 as it is wound on and off the reel.

Preferably the hosepipe is 20 meters long with 10 meters stored on the reel 30 and a 10-meter coil around the pole 41 of the water dispensing tool 40 (see FIG. 2C and 3A).

A water inlet 33 that connects to one end of the hosepipe 31 projects from the cover 32 of the reel 30 so that the hosepipe 31 can be connected to a water supply (not shown).

An end of the hosepipe 31 connects to a water dispensing tool 40.

The pictured embodiment has two water dispensing tools 40, a washing brush on an extendable pole 40A and a spray gun 40B.

The handle 21 has a mount 51 which has a plurality of brackets 50 that are for holding items.

In the pictured embodiment 100 one of the brackets 50 holds the pole 41 of the water dispensing tool 40A and one of the brackets 50 holds the spray gun 40B.

The invention has been described by way of examples only and it will be appreciated that variation may be made to the above-mentioned embodiments without departing from the scope of invention as defined by the claims.

1. A portable wash station comprising: a collapsible wheeled container with a base and a plurality of side walls that is configured to be arranged in a first collapsed position in which the base and side walls are parallel to one another and a second box position in which the base and side walls are assembled to define an open top storage box; an extendable handle provided on one side wall; and a reel that holds a hosepipe provided on an outer face of one side wall that is connectable to a water dispensing tool.

2. The portable wash station according to claim 1, including at least one bracket for receiving one or more item that includes the water dispensing tool.

3. The portable wash station according to claim 1 wherein the container when in the second position is a rectangular open topped box.

4. The portable wash station according to claim 1, wherein the extendable handle extends in the same axis as the side wall from one or more channel in the side wall.

5. The portable wash station according to claim 1, wherein the reel has a cover to enclose the hosepipe.

6. The portable wash station according to claim 2, including a mount onto which the at least one bracket is mounted.

7. The portable wash station according to claim 6, wherein the mount is mounted on the handle.

8. The portable wash station according to claim 1, wherein the container has at least one foot.

9. The portable wash station according to claim 1, wherein adjacent side walls are connected together by means of at least one first hinge.

10. The portable wash station according to claim 9, wherein the at least one first hinge is a displaceable clip.

11. The portable wash station according to claim 1, wherein the base is formed from two or more connecting parts.

12. The portable wash station according to claim 1, wherein one or more side wall is formed from two or more connecting parts.

13. The portable wash station according to claim 12, wherein the two or more connecting parts are connected by one or more second hinge.

14. The portable wash station according to claim 1, including at least one internal tray.

15. The portable wash station according to claim 14, wherein the internal tray is formed from at least two parts.

16. The portable wash station according to claim 14, wherein the first and second tray parts have corresponding interlocking means to join the first and second tray parts together.

17. The portable wash station according to claim 15, wherein each tray part includes a hole.

18. The portable wash station according to claim 15, wherein at least one tray part has a tab with a hole.

19. The portable wash station according to claim 1, including a water pump.

20. A method of collapsing the portable wash station according to claim 13 having a hinged base with first, second, third and fourth side walls connected to adjacent side walls by at least one first hinge wherein the second and fourth side walls are formed from two connecting parts joined by at least one second hinge, comprising the steps of: pulling the base upwards to align parallel with the first and third side wall; separating the at least two parts of the second and fourth side walls at the at least one second hinge and then folding each part about its first hinge(s) so that one part of each second and fourth side wall becomes parallel to the first side wall and the other part of each second and fourth wall becomes parallel to the third side wall; pushing the first and third side walls together to be parallel and adjacent one to another with the second and fourth side walls sandwiched therebetween.
